(19) United States
(12) Patent Application Publication
(10) Pub. No.: US 2024/0242901 A1
(43) Pub. Date: Jul. 18, 2024

(54) Metal-Graphene Coated Electrical Contact

(71) Applicant: ABB Schweiz AG, Baden (CH)

(72) Inventors: Anna Andersson, Västerås (SE); Su Zhao, Västerås (SE)

(21) Appl. No.: 18/559,380

(22) PCT Filed: Apr. 7, 2022
(86) PCT No.: PCT/EP2022/059227

§ 371 Date: Nov. 7, 2023

(30) Foreign Application Priority Data
May 10, 2021 (EP) 21173072.6

(51) Int. Cl. H01H 1/027; H01H 1/023; H01H 11/06; H01H 1/42

(52) U.S. Cl. CPC H01H 1/027; H01H 1/023; H01H 11/06; H01H 1/42; H01H 2229/014

(57) ABSTRACT

An electrical contact having a substrate of an electrically conductive non-silver material, and an electrically conductive metal-graphene composite coating directly on a surface of the substrate.

### TECHNICAL FIELD

The present disclosure relates to an electrical contact comprising a substrate and a coating on said substrate.

### BACKGROUND

In switch-disconnectors, electrical contacts are used. These are exposed both to electrical wear, via the electric arc during making/breaking, and mechanical wear, as the moving contact slides against the stationary contact during the transition between arcing area and main contact area. Both moving and stationary contacts are made of silver (Ag)-plated copper (Cu). Ag-plating is used to protect the copper from surface oxidation.

However, contacts with silver plating weld easily and have a high coefficient of friction. A lubricating grease is therefore used to maintain a high contact force as well as low friction and wear.

There are several issues using grease lubrication, e.g. evaporation and loss of grease with time, wear particles getting stuck in the grease, degradation that leads to higher viscosity, and at high temperatures (e.g. at arcing) grease decomposes and dries out forming a resistive film. These instabilities will eventually lead to increased contact resistance and overall temperature increase of the switching device. Also, an increased force may be needed to operate the device.

Lubricants with long-term thermal stability and corrosion resistance are not readily available. Solid-lubricant additives, like graphite or MoS₂, require a trade-off between mechanical/tribological and electrical properties.

CN 111519232 discloses use of a silver-graphene coating on top of a pure silver coating on a copper base metal of an electrical contact, to prevent sulfurization and corrosion of the silver-plated contact. The pure silver coating separates the base metal from the silver-graphene coating, thus preventing internal oxidation by the sulphur and oxygen in the base metal.

### SUMMARY

It is an objective of the present invention to provide an improved electrical contact.

According to an aspect of the present invention, there is provided an electrical contact comprising a substrate of an electrically conductive non-silver material, and an electrically conductive metal-graphene composite coating arranged directly on a surface of the substrate.

According to another aspect of the present invention, there is provided a switchgear comprising an embodiment of the electrical contact of the present disclosure.

According to another aspect of the present invention, there is provided a method of coating a substrate of an electrically conductive non-silver material for an electrical contact. The method comprises providing a metal-graphene electrolytic solution comprising graphene and metal ions. The method also comprises coating the substrate by electrodeposition whereby the graphene and metal ions are co-deposited to form an electrically conductive metal-graphene composite coating directly on a surface of the substrate.

By including graphene (G) in the metal, e.g. silver, coating of an electrical contact, the friction coefficient can be substantially reduced, whereby grease lubrication may no longer be needed. The graphene may thus provide a self-lubricating property to the coating. The graphene also improves the resistance to corrosion and heat, allowing the contact to better withstand arcing. The composite coating may still retain electrical conductivity, and low resistance, allowing the contact to be used as an electrically conducting contact, especially when the graphene content is low e.g. below 1 percent by weight (wt %) of the coating.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic circuit diagram of a switchgear, in accordance with some embodiments of the present invention.

FIG. 2 is a schematic side view of an electrical contact, in accordance with some embodiments of the present invention.

FIG. 3 is a schematic sectional side view of an electrodeposition bath, in accordance with some embodiments of the present invention.

FIG. 4 is a schematic flow chart of some embodiments of a method of the present invention.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

Herein the term graphene (G) is used collectively for carbon atoms in a 2D-honeycomb lattice in the form of mono-layer sheets, bi-layer sheets, few (3-5 layers)-layer sheets, or nano-platelets having a thickness of at most 50 nm, e.g. within the range of 1-50 nm. Also, when graphene is discussed herein, it should be understood that some of the graphene may be in the form of graphene oxide (GO) or reduced GO (rGO). Thus, the graphene may be pure graphene or comprise a mixture of pure graphene and GO and/or rGO.

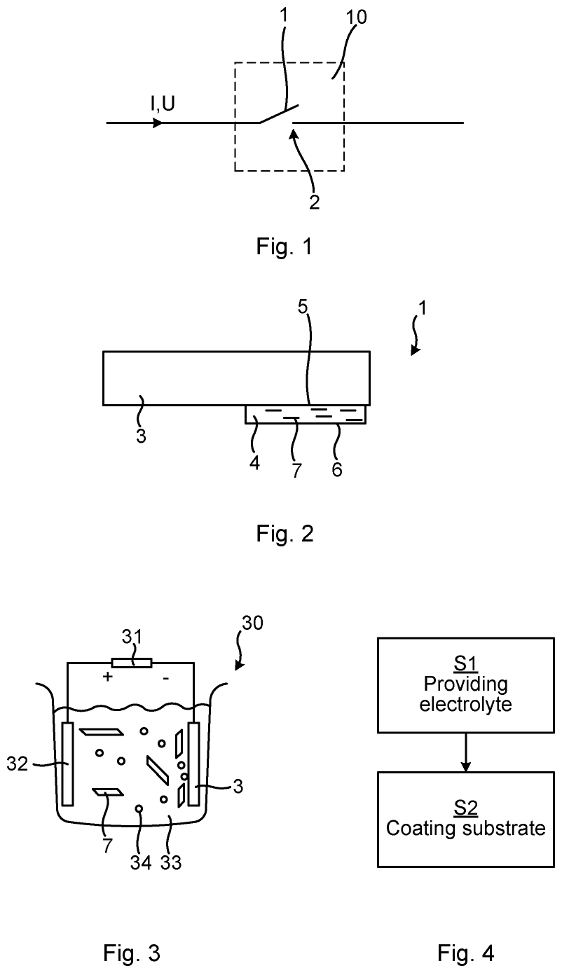

FIG. 1 illustrates a switchgear 10, e.g. a switch-disconnector, arranged for switching an electrical current I having a voltage U, alternating current (AC) or direct current (DC), comprising a contact arrangement 2 comprising a contact 1, typically of at least a pair of contacts in the contact arrangement 2 e.g. comprising a pair of contacts of which one is a stationary contact and another is a moving contact arranged to slide onto and off the stationary contact. Thus, the contact 1 may be a sliding contact, e.g. a knife contact. In a specific example, the contact 1 may be a stationary knife contact, e.g. of a switch-disconnector 10, arranged for sliding against a moving contact, but in other embodiments the contact 1 may be any suitable type of contact. In some embodiments, the sliding contact 1 is arranged to be squeezed between two parts of a moving contact arranged for rotating on/off the stationary electrical contact 1. If the electrical contact 1 is an arcing contact, it is arranged for handling arcing e.g. at an edge of the contact 1.

The switchgear is preferably for low voltage (LV) applications, having a nominal AC voltage of at most 1 kV, e.g. within the range of 0.1-1 kV, or a nominal DC voltage of at most 1.5 kV, e.g. within the range of 0.1-1.5 kV, or for applications of higher nominal voltages, having a nominal AC or DC voltage within the range of 1-70 kV, preferably LV applications. Thus, the switchgear 10, and thus the contact 1, may be configured for a nominal AC voltage of at most 1 kV or a nominal DC voltage of at most 1.5 kV.

The contact arrangement 2, and thus the contact 1 thereof, may be configured to be conducting, meaning that the contact 1 is arranged for conducting the current I when the switchgear 10 is closed (conducting). The contact 1 should thus have low resistance and high conductivity. The contact arrangement 2, and thus the contact 1, may also be arcing and thus being able to withstand an arc formed therein, especially if the switchgear is arranged for LV or MV applications, but not high voltage (HV) applications. Thus, in some embodiments, the contact 1 is an arcing (and typically also conducting) contact, part of an arcing contact arrangement 2 of the switchgear 10. In some embodiments, the switchgear 10 may be or comprise a switch-disconnector, configured for ensuring that an electrical circuit to which it is connected can be de-energized.

FIG. 2 illustrates the electrical contact 1, comprising a substrate 3 of an electrically conductive material, and a metal (Me) and graphene composite (MeG) coating 4 on said substrate, typically on a surface 5 of the substrate such that the composite coating 4 is in direct contact with the electrically conductive material of the substrate 3. The metal of the MeG composite should be electrically conductive and may typically be or comprise (preferably consist of) Cu and/or Ag, preferably Ag. The composite coating 4 may have a thickness of at most 100 μm, e.g. within the range of 1-100 μm or 10-50 μm.

The electrically conductive material of the substrate 3 may be metallic, e.g. comprising or consisting of (typically consisting of) Cu or aluminium (Al), preferably Cu.

The G content in the composite coating 4 may preferably be within the range of 0.1 to 1 wt %, e.g. within the range of 0.1 to 0.5 wt %, thus being a concentration which is low enough to not substantially impede the conductivity of the contact 1 while still providing self-lubricating properties as well as improved wear resistance and resistance to arcing and high temperatures. Preferably, the composite coating 4 may consist of only G and Me, with the G dispersed within an Me matrix. For improved arc resistance and/or anti-weld properties, all or at least a part of the G may be in the form of GO. Thus, the graphene in the coating 4 may preferably be or comprise graphene oxide.

The G is preferably present as few-layer graphene sheets 7 (also called nano-platelets herein) in the coating 4, with a preferable thickness within the range of 1-50 nm. The G sheets 7 each has a lateral size, herein discussed as a longest diameter, which is several times larger than the thickness, resulting in the platelet form (could also be called a flake or sheet form). In some embodiments, the G sheets 7 each has a longest diameter within the range of 5-80 μm. The G in the composite coating 4 greatly improves the corrosion resistance. It is believed that the G sheets 7 may naturally align themselves with the substrate surface 5 (e.g. as a result of electrodeposition discussed below), such that the sheets are generally arranged in parallel with the surface 5 being coated. The G sheets 7 may prevent diffusion of atoms (e.g. Cu) of the substrate 3 through the coating 4, which is a known problem when using e.g. pure Ag coatings, further preventing corrosion on the surface of the coated contact 1.

The coating 4 may, e.g. for a sliding contact 1, form a tribofilm on the contact surface during sliding. This solution gives a coefficient of friction vs. a pure Ag counter surface in the range 0.15-0.25, the same level compared to conventional greased Ag—Ag contacts. The graphene concentration is preferably not more than 1 wt %, preferably 0.5 wt % or even less. Since the graphene concentration is kept low, the electrical conductivity and contact resistance may be close to the same as for pure Me, e.g. Ag. In addition, a hardening effect is seen also at these low concentrations possibly due to a nanoparticle dispersion hardening, not seen for e.g. graphite at these low concentrations, which increases wear resistance. Finally, well-dispersed graphene platelets 7 result in an arc-erosion effect and weld resistance, typically at an arcing edge 6 of the coating 4, that is much improved over pure Ag. The multifunctionality of the coating 4 makes it ideal for an arcing LV contact 1 e.g. of a switch-disconnector.

The coating 4 is preferably made by electrodeposition (also called electroplating), but other coating methods such as cold spraying of Me and graphene powder mixtures of targeted concentrations, and laser sintering or oven sintering, are also possible.

FIG. 3 illustrates an electrodeposition arrangement or bath 30 for electrodeposition of the composite coating 4.

An MeG electrolytic solution 33, typically aqueous, comprises graphene 7, typically in the form of nano-platelets, and Me ions 34. The substrate 3 functions as a cathode and is, similar as a corresponding anode 32, e.g. an Ag anode especially if Me is Ag, connected to a voltage source 31. By applying a voltage, by the voltage source 31, between the substrate 3 and the anode 32, the graphene nano-platelets 7 and Me ions 34 are co-deposited onto a surface 5 of the substrate 3 to form the composite coating 4.

The Me ions 34 are typically provided by dissolving a metal salt, e.g. a silver salt such as AgNO₃, in the electrolytic solution 33. In some embodiments, the metal salt content in the solution 33 is within the range of 50-250 grams per litre (g/L). The graphene content in the solution 33 may typically be within the range of 0.01-1.5 g/L.

FIG. 4 illustrates some embodiments of a method of coating a substrate 3 of an electrically conductive non-silver material for an electrical contact 1. A metal-graphene electrolytic solution 33 is provided S1. The electrolytic solution 33 comprises graphene 7, e.g. in the form of nano-platelets, and metal ions 34, e.g. silver ions. Then, the substrate 3 is coated S2 by electrodeposition whereby the graphene 7 and metal ions 34 are co-deposited to form an electrically conductive metal-graphene composite coating 4 directly on a surface 5 of the substrate. That the composite coating is arranged directly on a surface 5 of the substrate implies that the metal, e.g. silver, of the composite coating 4 is in direct contact with the electrically conductive non-silver material, e.g. pure copper, of the substrate 3, without any intermediate layer therebetween.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. An electrical contact comprising:
a substrate of an electrically conductive non-silver material; and
an electrically conductive metal-graphene composite coating directly on a surface of the substrate,
wherein the graphene content in the coating (4) is within the range of 0.1 to 1 wt %.

2. The contact of claim 1, wherein the metal of the metal-graphene composite coating is silver or copper, preferably silver.

3. The contact of claim 1, wherein the graphene content in the coating is within the range of 0.1 to 0.5 wt %.

4. The contact of claim 1, wherein the graphene is in the form of sheets having a thickness within the range of 1-50 nm.

5. The contact of claim 4, wherein the sheets have a longest diameter within the range of 5-80 μm.

6. The contact of claim 1, wherein the contact is configured as a sliding contact.

7. The contact of claim 1, wherein the substrate material is or comprises copper and/or aluminium, preferably wherein the substrate material is copper.

8. A switchgear comprising at least one electrical contact having a substrate of an electrically conductive non-silver material; and
an electrically conductive metal-graphene composite coating directly on a surface of the substrate,
wherein the graphene content in the coating (4) is within the range of 0.1 to 1 wt %.

9. The switchgear of claim 8, wherein the switchgear is configured for applications with a nominal AC or DC voltage of at most 70 kV, e.g. low voltage applications.

10. The switchgear of claim 8, wherein the switchgear is a switch-disconnector.

11. The switchgear of claim 10, wherein the electrical contact is part of an arcing contact arrangement of the switch-disconnector.

12. The switchgear of any claim 8, wherein the electrical contact is a sliding contact.

13. The switchgear of claim 12, wherein the sliding contact is a knife contact.

14. A method of coating a substrate of an electrically conductive non-silver material for an electrical contact, the method comprising: providing a metal-graphene electrolytic solution having graphene and metal ions; and
coating the substrate by electrodeposition whereby the graphene and metal ions are co-deposited to form an electrically conductive metal-graphene composite coating directly on a surface of the substrate
wherein the graphene content in the solution is within the range of 0.01-1.5 g/L.

15. The method of claim 14, wherein the metal ions consist of or comprise silver ions.
